(19) United States
(12) Patent Application Publication
(10) Pub. No.: US 2005/0016756 A1
(43) Pub. Date: Jan. 27, 2005

(54) Trace wire for transmission of a tone for locating underground utilities and cables

(75) Inventor: David E. Vokey, Bellingham, WA (US)

Correspondence Address: STITES & HARBISON PLLC, 1199 NORTH FAIRFAX STREET, SUITE 900, ALEXANDRIA, VA, 22314, US

(73) Assignee: Norscan Instruments Ltd., Winnipeg (CA)

(21) Appl. No.: 10/849,564

(22) Filed: May 20, 2004

Related U.S. Application Data
(63) Continuation-in-part of application No. 10/193,248, filed on Jul. 12, 2002, now Pat. No. 6,750,401.

(30) Foreign Application Priority Data
Aug. 29, 2002 (CA) 2,400,130

(51) Int. Cl. H01B 7/00

(52) U.S. Cl. 174/120 R

(57) ABSTRACT

A trace wire is placed alongside an underground utility for long distance transmission of locating tones. The trace wire has a conductive core and an electrically insulating sheath on the core. The sheath has an outer layer of solid dielectric material surrounding the core, the outer layer having a predetermined weight per unit length and an inner layer comprising a solid foam of dielectric material filling the space between the core and the outer layer. the flexural rigidity ratio of the insulating sheath is given by:
F_{rb}/Fᵣₐ≧4 where:
F_{rb} is the flexural rigidity of the outer layer
Fᵣₐ is the flexural rigidity of a minimum outer diameter sheath of said solid dielectric material. This combination of a core conductor with insulating materials in a multi-layered design provides significantly improved properties over current commercially available insulated conductors when used as trace wires. In the presently preferred embodiment of the invention, the trace wire construction includes a. 1.6 mm (14 AWG) hard drawn copper conductor to provide low resistance along with high break strength. The inner layer of the sheath is gas injected foamed polyethylene (PE) insulation applied to an overall diameter of 7 mm. The outer layer is solid, medium or high density PE applied over the first layer to an over all outer diameter of 8.5 mm. This dual-layer insulation exhibits an effective relative dielectric constant of about 1.6. The attenuation constant at 500 Hz is 0.227 dB per km maximum. The break strength is about 135 kg and the trace wire is light weight at about 36 grams per meter.

### CROSS REFERENCE TO RELATED APPLICATIONS

The present application is a continuation-in-part of application 10/193,248, filed Jul. 12, 2002, which is incorporated herein by reference.

### FIELD OF THE INVENTION

The present invention relates to locating underground cables, pipes and utilities, and more particularly to a trace wire that is used to carry a locating tone to be detected by a hand-held receiver in order to determine the precise location of the underground utility.

### BACKGROUND

Buried underground, particularly in the modern urban environment, is a virtual maze of utilities. These include wires, fibre optic cables, pipes and conduits for utilities including telephone, electricity, gas, cable television, traffic signals, street lighting, drainage and flood control, water distribution, and waste water collection. Frequently, these are buried in close proximity to one another and are susceptible to damage due to construction equipment excavating in their vicinity.

The clear identification and location of the underground utilities is of the utmost importance to avoid dig-ups and damage. However, the records are often poor with inaccurate utility locations and depths. Some lines are not even recorded.

For location purposes, a trace wire is often placed in a duct or buried directly along with the utility in an attempt to provide a means for locating the utility prior to excavation in the area. The utility is located by transmitting a locating tone on the trace wire. A special receiver with magnetic field detecting coils is used to sense the tone current travelling along the trace wire. By this means the path and depth of the trace wire, and therefore the utility may be determined.

Typical trace wires used range from commercially available PVC insulated building wire to marker tapes with integral tracing wire. In practice, the trace wires used are often less than adequate. The standard commercial grade wire is not well suited for this application. The smaller gage wires often break or are damaged and present a high attenuation to the tone signal, which limits the useful locate distance. Larger gauge conductors, such as an insulated #6 AWG, have been used to lower the attenuation rate in an effort to reach greater distances. This improvement is offset by an increase in size and weight, which is detrimental for the installation process. Installation in ducts is conventionally done by using either a blow-in or pull-in technique. Good blow-in performance requires a low weight and good rigidity to prevent buckling during the installation. For pull-in, the tensile strength must be sufficiently high that the yield point of the wire is not exceeded.

The present invention makes use of a unique combination of insulation and conductor to achieve the desired results for a trace wire application.

### SUMMARY

According to the present invention, there is provided a trace wire to be placed alongside an underground utility for long distance transmission of locating tones, said trace wire comprising:
a conductive core;
an electrically insulating sheath on the core, said sheath comprising:
   an outer layer of solid dielectric material surrounding the core, the outer layer having a predetermined weight per unit length, wherein:
      F_{rb}/Fᵣₐ≧4
      where:
F_{rb} is the flexural rigidity of the outer layer
Fᵣₐ is the flexural rigidity of a minimum diameter sheath of said solid dielectric material with said predetermined weight per unit length.; and
an inner layer comprising a solid foam of dielectric material filling any space between the core and the outer layer.

The “minimum diameter sheath” is a hypothetical sheath of the same weight per unit length with its inner surface engaged with the outer surface of the conductor, as will be discussed more fully in the following.

This trace wire configuration results in excellent rigidity and a low weight per unit length as required for installation. It may be used with underground utilities of any type, for example cables, pipes and ducts.

The use of this combination of a core conductor and insulating materials in a multi-layered design provides significantly improved properties over current commercially available insulated conductors when used as trace wires.

In the presently preferred embodiment of the invention, the trace wire construction includes a. 1.6 mm (14 AWG) hard drawn (HD) copper conductor to provide low resistance along with high break strength. The inner layer of the sheath is gas injected foamed polyethylene (PE) insulation applied to an overall diameter of 7 mm. The outer layer is solid, medium or high density PE applied over the first layer to an overall outer diameter of 8.5 mm. This dual-layer insulation exhibits an effective relative dielectric constant of about 1.6. The attenuation constant at 500 Hz is 0.227 dB per km maximum. The break strength is about 135 kg and the trace wire is light weight at about 36 gm/m.

The hard drawn copper conductor provides good tensile strength and rigidity as compared with a conventional copper wire, in which the conductor is ductile to provide a product amenable to bending during installation. In such wires, the conductor may be annealed to relieve internal stresses, thus limiting brittleness, but reducing yield strength under tension.

### BRIEF DESCRIPTION OF THE DRAWINGS

In the accompanying drawings, which illustrate an exemplary embodiment of the present invention:

FIG. 1a is a cross-section of an conductor insulated with a minimum diameter sheath;

FIG. 1b is a cross-section of a conductor with a layer of insulation material having a larger external diameter and the same cross-sectional area as the insulation in FIG. 1a;

FIG. 2 illustrates a tracing system using a tone generator, a trace wire and a termination circuit connected in a ground return configuration;

FIG. 3 is a graph illustrating the ratio of flexural rigidity for a fixed cross-sectional area and varying outer diameter;

FIG. 4 is an isometric illustration of a multi-layered trace wire; and

FIG. 5 is a graph illustrating the trace wire rigidity vs. the ratio of flexural rigidity of the insulating sheath

### DETAILED DESCRIPTION

Before referring in detail to the drawings, it will be useful to consider the preferred characteristics of a trace wire, both electrical and mechanical.

Preferred Performance Requirements

An optimum trace wire should incorporate several key features:
1. The structure should be mechanically rigid to prevent buckling and folding back on itself during blow-in installation in a typical underground plastic duct. This flexural rigidity is of great importance. While exhibiting this high degree of rigidity, the trace wire weight must be kept as low as possible. This results in superior performance with blow in and pull in installation techniques.
2. The outer layer of the trace wire should be composed of a smooth, rugged insulating material to provide a low coefficient of friction and withstand installation abrasion.
3. The over-all structure should have high tensile strength to facilitate long length pull-in in underground ducts.
4. To ensure maximum locate distance and accurate locates, the trace wire should exhibit low loss characteristics at the tone locating frequencies of interest.

For a given maximum weight per unit length of trace wire, an acceptable combination of copper conductor and plastic insulation must be formulated.

Weight

For purposes of this discussion, a total trace wire weight of 36 grams per meter (gm/m) will be discussed. It is to be understood that other values may prove suitable.

Flexural Rigidity

Hard drawn copper has a modulus of rigidity of about 6400 ksi. High density polyethylene has a modulus of rigidity of 200 ksi. In the hypothetical extremes solid elements of copper or polyethylene (PE) at the maximum weight could be selected. As noted above, in the present example, the combined weight of the PE insulating sheath and the copper conductor amounts to 36 grams per meter (gm/m). A solid copper conductor of 36 gm/m would yield a rigidity factor of 50 k. A solid PE element of 36 gm/m would yield a rigidity factor of about 12. The desired result is a trace wire with high rigidity and conductance and insulation suitable for good electrical performance.

Although the flexural rigidity of a solid PE element is very much less than that of a solid copper element, the insulating layer formed over the trace wire conductor can be configured to contribute considerably to the flexural rigidity. For an insulating layer over a conductor the flexural rigidity Fᵣ is given by:
Fᵣ=Eπ(D⁴−d⁴)/64 (1)
where: D is the outer diameter of the insulation;
d is the inner diameter of the insulation;
E is the modulus of elasticity of the material;

For a typical insulated conductor d would also be the outer diameter of the conductor.

The total cross-sectional area of the insulation is given by:
A=π(D²−d²/4 (2)

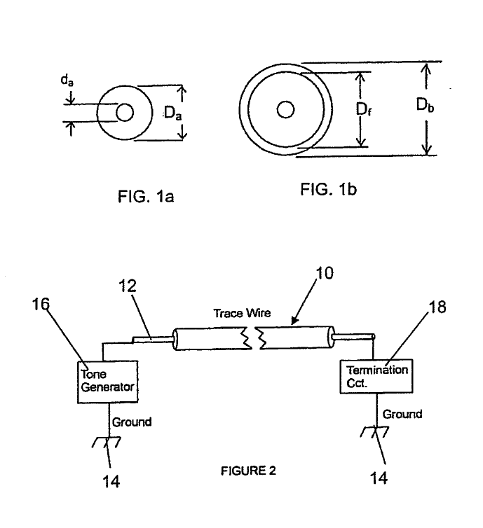

The insulating layer forms a cylindrical tube over the conductor. Considering the case for a fixed cross-sectional area A of an insulating material, and therefore a fixed weight per unit length, the insulation can be applied such that the inner surface of the tube is in tight contact with the conductor as illustrated in FIG. 1a. This is the “minimum diameter sheath” to which reference has been made above. This sheath has an outer diameter of Dₐ. Applying the same cross sectional area A of the same material, which implies the same weight per unit length, while allowing the outer diameter of the insulation to increase, results in a tube with a thinner wall thickness and larger outer diameter D_{b}, as illustrated in FIG. 1b.

For these two cases, as shown in FIGS. 1a and 1b, the ratio of the flexural rigidities (the “flexural rigidity ratio”) for the two outer insulation diameters is given by:
F_{rb}/Fᵣₐ=(D_{b}²−2A/π)/(Dₐ²−2A/π) (3)
where: F_{rb} is the flexural rigidity of the insulation as illustrated in FIG. 1b;
Fᵣₐ is the flexural rigidity of the minimum diameter sheath illustrated in FIG. 1a;
Dₐ is the outer diameter of the minimum diameter sheath;
D_{b} is the larger outer diameter of the insulation when spaced from the conductor.

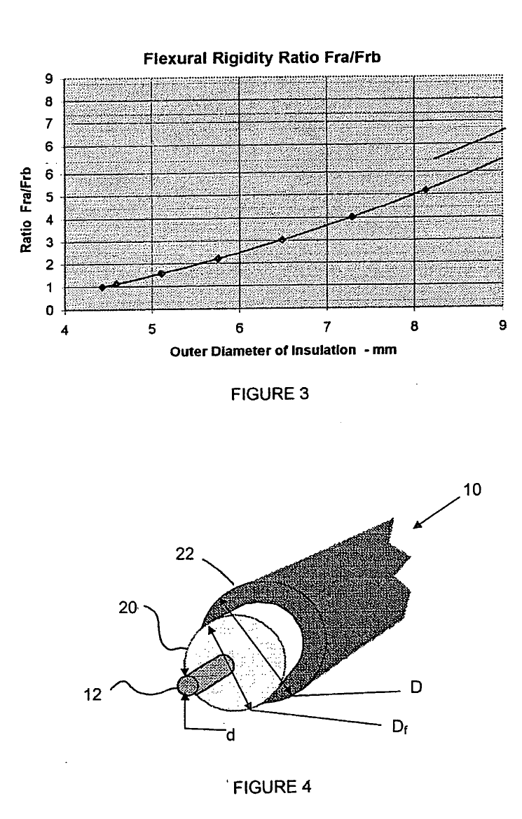

As can be seen in Equation (3) and as illustrated in FIG. 3, the flexural rigidity ratio increases approximately as the ratio of the squares of the outer diameters. This implies that, for a given amount of insulating material, a more rigid cylindrical structure is realized by increasing the outer diameter while allowing the wall thickness to decrease. The rigidity increases without increasing the amount and therefore weight of insulating material.

With a fixed cross-sectional area, as the outer diameter is increased, the inner diameter will also increase and will exceed the diameter of the conductor. This results in the conductor fitting loosely in the insulation. For good electrical and mechanical performance, it is important to maintain the conductor in the centre of the insulating structure and mechanically coupled to the insulation. How this may be achieved is discussed in the following.

Tensile Strength

High tensile strength is required to allow long length pull-in capability. The conductor and the outer layer of insulating material provide the tensile strength. The modulus of elasticity of the solid insulation should be as high as possible to enhance both structural rigidity and tensile strength. To ensure low series resistance, the conductor will typically be made of solid copper. The solid copper conductor should be hard drawn (HD). HD copper is more rigid and has a break strength approximately twice that of annealed copper such as is used in most conventional wire configurations. The conventional copper wires are annealed to reduce brittleness and increase ductility. Using HD copper adds greatly to both the rigidity and pull-in performance of the present design.

Analysis of the Trace Wire as a Transmission Line

The trace wire 10 can be considered a form of coaxial transmission line with the copper conductor 12 as the inner conductor and earth (ground 14) as the outer conductor as shown in FIG. 4. A signal tone is applied to one end of the core conductor 12 by a tone generator 16. The opposite end of the conductor is connected to ground by a termination circuit 18 which controls, either passively or actively, the current in the wire.

At frequencies of a few kilohertz or less the attenuation of the transmission line is closely approximated by:
α=8.686(πfRC)^{1/2}db/km (4)
where: f is the frequency in cycles per second
R is the armour or shield resistance per km
C s the wire capacitance to ground per km

To maximize the tracing distance, the attenuation should be made as small as possible. As seen in equation (4), this is accomplished by decreasing the series resistance, the capacitance to ground or both. Reducing the series resistance requires an increase in the conductor diameter thereby increasing the weight and cost of the trace wire. Reducing the capacitance to ground can be achieved by increasing the insulation thickness but this also can add significantly to the weight and cost.

A more effective means to reduce the capacitance to ground is to reduce the dielectric constant. This can be accomplished by foaming the insulation material by injecting an inert gas during the insulation process. However, the resulting solid foam insulation has a much lower modulus of elasticity and exhibits low structural rigidity.

The present design employs a layered insulation as illustrated in FIG. 4. For an insulated conductor covered by two layers of insulation the capacitance to ground is given by:
Ct=0.0555*k_{f}*kₛ/(k_{f}*1r(D_{b}/D_{f})+kₛ*1r(D_{f}/d))μF/meter (5)
where: D_{b} is the diameter of the outer layer of insulation
D_{f} is the diameter of the inner layer of insulation
Kₛ is the relative dielectric constant of the outer layer of insulation
K_{f} is the relative dielectric constant of the inner layer of insulation
d is the conductor diameter
   Trace Wire Design Details

With continuing Reference to FIG. 4 of the drawings, a hard drawn copper conductor 12 is used to maximize tensile strength and rigidity of the conducting element. For the presently preferred design as illustrated, a copper conductor of 1.6 mm (14 AWG) diameter is used. The break strength of the insulated wire with HD copper is nearly 135 kg, which provides excellent pull-in performance.

The conductor is insulated to an overall diameter of 7 mm with a solid foam polyethylene 20 foamed by gas injection to a level of approximately 50% polyethylene and 50% inert gas. This increases the overall diameter without significantly increasing the weight and reduces the combined relative dielectric constant to about 1.6 from 2.3 for solid insulation.

The present design also provides increased flexural rigidity for a fixed volume of solid insulating material by not constraining the inner diameter of the solid insulation while tightly capturing the conductor in the centre of the structure.

A solid insulating material 22 for example high or medium density polyethylene is extruded over the foam insulation to an overall diameter of 8.5 mm. This adds greatly to the flexural rigidity and abrasion resistance. For the solid insulation layer with an outer diameter of 8.5 mm and inner diameter of 7 mm the cross sectional area of insulation is 18.25 mm². Applying the same amount of insulation directly over the 1.6 mm conductor in the minimum diameter sheath configuration of FIG. 1a would result in an outer diameter of 5.08 mm. Therefore, from equation (1) with the cross sectional area of insulating material held constant, the flexural rigidity of the 8.5 mm outer diameter relative to the 5.08 mm diameter is greater by a factor of 5.9.

The dual insulated layer design results in a coaxial capacitance of about 0.052 μF per km. A similar conductor with a single layer of solid insulation would exhibit a coaxial capacitance of about 0.077 μF per km. From equation (4) the attenuation at a locate frequency of 500 Hz is 0.227 dB/km for the dual layer insulation and 0.273 dB/km for the single layer insulation. A typical cable locate system has a dynamic range of about 30 dB. This yields a locate distance of 110 km for the single layer design and 132 km for the dual layer design, a 20% improvement in locate distance.

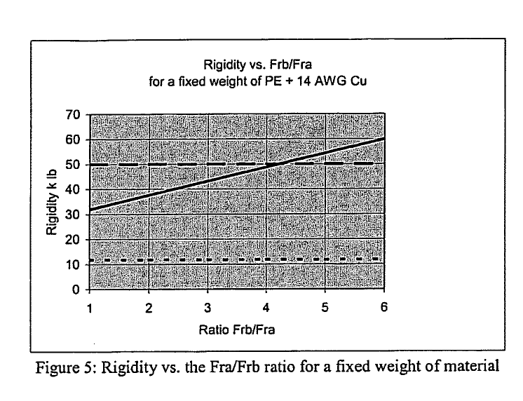

FIG. 5 is a graph of trace wire rigidity vs., the design ratio F_{rb}/Fᵣₐ· for a 36 gm/m wire. A line at 50 k represents a case where the entire material weight of 36 gm/m is provided by the copper element alone. At the other extreme, a line at 12 k represents a case where the entire weight is provided by the solid PE. The line designated PE+Cu illustrates a fixed weight of copper at 19.1 gm/m (14 AWG) and PE at a fixed weight of 16.9 gm/m. As illustrated, with a fixed weight of PE, increasing the outer diameter of the sheath increases both the ratio F_{rb}/Fᵣₐ and the rigidity of the trace wire. It can be seen that with a ratio F_{rb}/Fᵣₐ≧4, the combined rigidity is greater than that for an HD copper wire of 36 gm/m.

Thus, by employing a unique combination of conductors and insulating materials a trace wire design has been realized which has superior tensile strength, flexural rigidity, abrasion resistance combined with light weight and, low attenuation. This results in excellent installation properties and extended tracing distances.

While specific reference has been made in the foregoing to a particular, currently preferred embodiment of the invention, it is to be understood that the invention is not limited to that specific embodiment. Other embodiments are possible using other materials and different dimensions, based on the properties of those materials, the intended installation technique and the intended end use of the wire.

1. A trace wire to be placed alongside an underground utility for long distance transmission of locating tones, said trace wire comprising:
a conductive core;
an electrically insulating sheath on the core, said sheath comprising:
an outer layer of solid dielectric material surrounding the core, the outer layer having a predetermined weight per unit length; and
an inner layer comprising a solid foam of dielectric material filling space between the core and the outer layer;
and wherein:
F_{rb}/Fᵣₐ≧4
where:
F_{rb} is the flexural rigidity of the outer layer
Fᵣₐ is the flexural rigidity of a minimum outer diameter sheath of said solid dielectric material.

2. A trace wire according to claim 1 wherein the conductor comprises a copper wire.

3. A trace wire according to claim 2 wherein the conductor comprises a. 1.6 mm diameter (14 AWG) hard drawn copper conductor.

4. A trace wire according to claim 1 wherein the inner layer of the sheath is solid foam polyethylene (PE) insulation

5. A trace wire according to claim 4 wherein the inner layer of the sheath has an outer diameter of 7 mm .

6. A trace wire according to claim 1 wherein the outer layer of the sheath is solid polyethylene.

7. A trace wire according to claim 6 wherein the outer layer of the sheath has an outer diameter of 8.5 mm.
